(19) United States
(12) Patent Application Publication
(10) Pub. No.: US 2020/0126086 A1
(43) Pub. Date: Apr. 23, 2020

(54) FRAUDULENT TRANSACTION DETECTION MODEL TRAINING

(71) Applicant: Alibaba Group Holding Limited, George Town (KY)

(72) Inventor: Longfei Li, Hangzhou (CN)

(73) Assignee: Alibaba Group Holding Limited, George Town (KY)

(21) Appl. No.: 16/722,899

(22) Filed: Dec. 20, 2019

Related U.S. Application Data
(63) Continuation of application No. 16/257,937, filed on Jan. 25, 2019.

(30) Foreign Application Priority Data
Jan. 26, 2018 (CN) 201810076249.9

(51) Int. Cl. G06Q 20/40; G06N 5/04; G06N 3/08; G06F 21/31

(52) U.S. Cl. CPC G06Q 20/4016; G06F 21/316; G06N 3/08; G06N 5/046

(57) ABSTRACT

By a computing platform, a classification sample set is obtained from a user operation record, where the classification sample set includes calibration samples, where each calibration sample includes a user operation sequence and a time sequence. For each calibration sample and at a convolution layer of a fraudulent transaction detection model: a first convolution processing is performed on the user operation sequence to obtain first convolution data and a second convolution processing is performed on the time sequence to obtain second convolution data; the first convolution data is combined with the second convolution data to obtain time adjustment convolution data, and the time adjustment convolution data is entered to a classifier layer of the fraudulent transaction detection model to generate a classification result; and the fraudulent transaction detection model is trained using the classification result. A fraudulent transaction is detected using the trained fraudulent transaction detection model.

### CROSS-REFERENCE TO RELATED APPLICATIONS

This application claims priority to U.S. application Ser. No. 16/257,937, filed on Jan. 25, 2019, which claims priority to Chinese Patent Application No. 201810076249.9, filed on Jan. 26, 2018, which are hereby incorporated by reference in its entirety.

### TECHNICAL FIELD

One or more implementations of the present specification relate to the field of computer technologies, and in particular, to a method for training a fraudulent transaction detection model, a method for detecting a fraudulent transaction, and a corresponding apparatus.

### BACKGROUND

Development of Internet technologies makes people's life more and more convenient, and people can use networks to perform various transactions and operations such as shopping, payment, and transfer. However, security issues caused by network transactions and operations also become more serious. In recent years, financial fraud happens occasionally, and some people induce users to perform fraudulent transactions by all means. For example, some fraudulent links are disguised as official links of banks or telecomm companies to induce the user to pay fees or transfer certain amounts; or some false information is used to induce the users to operate E-bank or E-wallet for fraudulent transactions. As such, fraudulent transactions need to be quickly detected and identified, so that corresponding actions can be taken to avoid or reduce user's property losses and improve security of network financial platforms.

In the existing technology, methods such as logistic regression, random forest, and deep neural networks are used to detect fraudulent transactions. However, detection methods are not comprehensive, and results are not accurate enough.

Therefore, a more efficient method is needed to detect fraudulent transactions in financial platforms.

### SUMMARY

One or more implementations of the present specification describe a method and an apparatus, to use time factors of a user operation to train a fraudulent transaction detection model, and detect a fraudulent transaction by using the model.

According to a first aspect, a method for training a fraudulent transaction detection model is provided, where the fraudulent transaction detection model includes a convolution layer and a classifier layer, and the method includes: obtaining a classification sample set, where the classification sample set includes a plurality of calibration samples, the calibration sample includes a user operation sequence and a time sequence, the user operation sequence includes a predetermined quantity of user operations, the predetermined quantity of user operations are arranged in chronological order, and the time sequence includes a time interval between adjacent user operations in the user operation sequence; performing first convolution processing on the user operation sequence at the convolution layer, to obtain first convolution data; performing second convolution processing on the time sequence, to obtain second convolution data; combining the first convolution data with the second convolution data, to obtain time adjustment convolution data; and entering the time adjustment convolution data to the classifier layer, and training the fraudulent transaction detection model based on a classification result of the classifier layer.

In an implementation, before first convolution processing is performed on the user operation sequence, the user operation sequence is processed to obtain an operation matrix.

In an implementation, the user operation sequence is processed by using a one-hot encoding method or a word embedding method to obtain an operation matrix.

In an implementation, during second convolution processing, a plurality of elements in the time sequence are successively processed by using a convolution kernel of a predetermined length k, to obtain a time adjustment vector A serving as the second convolution data, where a dimension of the time adjustment vector A is corresponding to a dimension of the first convolution data.

In an implementation, a vector element ai in the time adjustment vector A is obtained by using the following formula:

$${a}_{i} = f ( - {\sum }_{j = 1}^{k} {x}_{i + j} * {C}_{j} ) ,$$

where f is a transformation function, xi is the ith element in the time sequence, and Cj is a parameter associated with the convolution kernel.

In an example, the transformation function f is one of a tanh function, an exponential function, and a sigmoid function.

In an implementation, the combining the first convolution data with the second convolution data includes: performing point multiplication combining on a matrix corresponding to the first convolution data and a vector corresponding to the second convolution data.

In an implementation, the convolution layer of the fraudulent transaction detection model includes a plurality of convolution layers, and correspondingly, time adjustment convolution data obtained at a previous convolution layer is used as a user operation sequence of a next convolution layer for processing, and time adjustment convolution data obtained at the last convolution layer is output to the classifier layer.

According to a second aspect, a method for detecting a fraudulent transaction is provided, where the method includes: obtaining a sample that is to be detected, where the sample that is to be detected includes a user operation sequence that is to be detected and a time sequence that is to be detected, the user operation sequence that is to be detected includes a predetermined quantity of user operations, the predetermined quantity of user operations are arranged in chronological order, and the time sequence that is to be detected includes a time interval between adjacent user operations in the user operation sequence that is to be detected; and entering the sample that is to be detected to a fraudulent transaction detection model, so that the fraudulent transaction detection model outputs a detection result, where the fraudulent transaction detection model is a model obtained through training by using the method according to the first aspect.

According to a third aspect, an apparatus for training a fraudulent transaction detection model is provided, where the fraudulent transaction detection model includes a convolution layer and a classifier layer, and the apparatus includes: a sample set acquisition unit, configured to obtain a classification sample set, where the classification sample set includes a plurality of calibration samples, the calibration sample includes a user operation sequence and a time sequence, the user operation sequence includes a predetermined quantity of user operations, the predetermined quantity of user operations are arranged in chronological order, and the time sequence includes a time interval between adjacent user operations in the user operation sequence; a first convolution processing unit, configured to perform first convolution processing on the user operation sequence at the convolution layer, to obtain first convolution data; a second convolution processing unit, configured to perform second convolution processing on the time sequence, to obtain second convolution data; a combination unit, configured to combine the first convolution data with the second convolution data, to obtain time adjustment convolution data; and a classification training unit, configured to enter the time adjustment convolution data to the classifier layer, and train the fraudulent transaction detection model based on a classification result of the classifier layer.

According to a fourth aspect, an apparatus for detecting a fraudulent transaction is provided, where the apparatus includes: a sample acquisition unit, configured to obtain a sample that is to be detected, where the sample that is to be detected includes a user operation sequence that is to be detected and a time sequence that is to be detected, the user operation sequence that is to be detected includes a predetermined quantity of user operations, the predetermined quantity of user operations are arranged in chronological order, and the time sequence that is to be detected includes a time interval between adjacent user operations in the user operation sequence that is to be detected; and a detection unit, configured to enter the sample that is to be detected to a fraudulent transaction detection model, so that the fraudulent transaction detection model outputs a detection result, where the fraudulent transaction detection model is a model obtained through training by using the apparatus according to the third aspect.

According to a fifth aspect, a computer readable storage medium is provided, where the computer readable storage medium stores a computer program, and when being executed on a computer, the computer program enables the computer to perform the method according to the first aspect or the method according to the second aspect.

According to a sixth aspect, a computing device is provided, and includes a memory and a processor, where the memory stores executable code, and when executing the executable code, the processor implements the method according to the first aspect or the method according to the second aspect.

According to the method and the apparatus provided in the implementations of the present specification, a time sequence is introduced to input sample data of a fraudulent transaction detection model, and a time adjustment parameter is introduced to a convolution layer, so that a time sequence of a user operation and an operation time interval are considered in a training process of the fraudulent transaction detection model, and a fraudulent transaction can be detected more comprehensively and more accurately by using the fraudulent transaction detection model obtained through training.

### BRIEF DESCRIPTION OF DRAWINGS

To describe the technical solutions in the implementations of the present disclosure more clearly, the following briefly describes the accompanying drawings required for describing the implementations. Apparently, the accompanying drawings in the following description merely show some implementations of the present disclosure, and a person of ordinary skill in the art may still derive other drawings from these accompanying drawings without creative efforts.

FIG. 1 is a schematic diagram illustrating an implementation scenario, according to an implementation of the present specification;

FIG. 2 is a flowchart illustrating a method for training a fraudulent transaction detection model, according to an implementation;

FIG. 3 is a schematic diagram illustrating a fraudulent transaction detection model, according to an implementation;

FIG. 4 is a schematic diagram illustrating a fraudulent transaction detection model, according to another implementation;

FIG. 5 is a flowchart illustrating a method for detecting a fraudulent transaction, according to an implementation;

FIG. 6 is a schematic block diagram illustrating an apparatus for training a fraudulent transaction detection model, according to an implementation;

FIG. 7 is a schematic block diagram illustrating an apparatus for detecting a fraudulent transaction, according to an implementation; and

FIG. 8 is a flowchart illustrating an example of a computer-implemented method for training a fraudulent transaction model, according to an implementation of the present disclosure.

### DESCRIPTION OF IMPLEMENTATIONS

The following describes the solutions provided in the present specification with reference to the accompanying drawings.

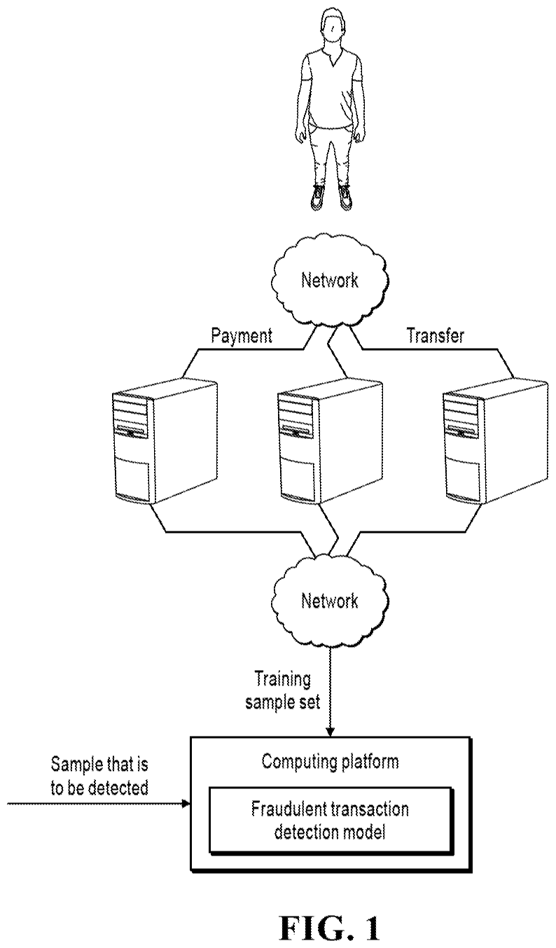

FIG. 1 is a schematic diagram illustrating an implementation scenario, according to an implementation of the present specification. As shown in FIG. 1, a user may perform a plurality of transaction operations by using networks, for example, payment and transfer. Correspondingly, a server corresponding to the transaction operation, for example, an ALIPAY server, can record an operation history of the user. It can be understood that a server that records the operation history of the user can be a centralized server, or can be a distributed server. This is not limited here.

To train a fraudulent transaction detection model, a training sample set can be obtained from a user operation record recorded in the server. Specifically, some fraudulent transaction operations and normal operations can be predetermined in a manual calibration method or another method. Then, a fraudulent sample and a normal sample are obtained, the fraudulent sample includes a fraudulent transaction operation and a fraudulent operation sequence constituted by historical operations prior to the fraudulent operation, and the normal sample includes a normal operation and a normal operation sequence constituted by historical operations prior to the normal operation. In addition, time information in the operation history, that is, a time interval between operations, is further obtained, and these time intervals constitute a time sequence.

A computing platform can obtain the fraudulent sample and the normal sample as described above, and each sample includes a user operation sequence and a corresponding time sequence. The computing platform trains the fraudulent transaction detection model based on the operation sequence and the time sequence. More specifically, the user operation sequence and the corresponding time sequence are processed by using a convolutional neural network, to train the fraudulent transaction detection model.

After the fraudulent transaction detection model is obtained through training, a user operation sequence and a time sequence are also extracted from a transaction sample that is to be detected, and the user operation sequence and the time sequence are entered to the model obtained through training, to output a detection result, that is, whether a current transaction that is to be detected is a fraudulent transaction.

The previously described computing platform can be any apparatus, device, or system having a computing and processing capability, for example, can be a server. The computing platform can be used as an independent computing platform, or can be integrated to the server that records the operation history of the user. As described above, in the process of training the fraudulent transaction detection model, the computing platform introduces the time sequence corresponding to the user operation sequence, so that the model can consider a time sequence of a user operation and an operation interval to more comprehensively describe and obtain a feature of the fraudulent transaction, and more effectively detect the fraudulent transaction. The following describes a specific process that the computing platform trains the fraudulent transaction detection model.

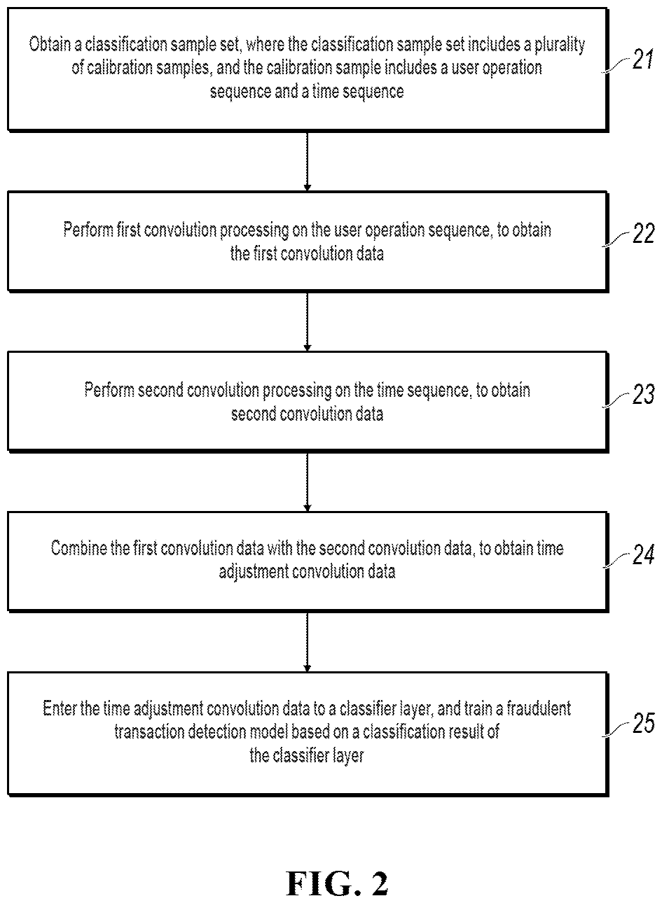

FIG. 2 is a flowchart illustrating a method for training a fraudulent transaction detection model, according to an implementation. For example, the method can be performed by the computing platform in FIG. 1, and the computing platform can be any apparatus, device, or system having a computing and processing capability, for example, can be a server. As shown in FIG. 2, the method for training a fraudulent transaction detection model can include the following steps: Step 21: Obtain a classification sample set, where the classification sample set includes a plurality of calibration samples, the calibration sample includes a user operation sequence and a time sequence, the user operation sequence includes a predetermined quantity of user operations, the predetermined quantity of user operations are arranged in chronological order, and the time sequence includes a time interval between adjacent user operations in the user operation sequence. Step 22: Perform first convolution processing on the user operation sequence at a convolution layer of the fraudulent transaction detection model, to obtain first convolution data. Step 23: Perform second convolution processing on the time sequence, to obtain second convolution data. Step 24: Combine the first convolution data with the second convolution data, to obtain time adjustment convolution data. Step 25: Enter the time adjustment convolution data to a classifier layer, and train the fraudulent transaction detection model based on a classification result of the classifier layer. The following describes a specific execution process of each step.

First, in step 21, the classification sample set used for training is obtained. The classification sample set includes a plurality of calibration samples, and the calibration sample includes the user operation sequence and the time sequence. As known by a person skilled in the art, to train the model, some calibrated samples are needed to serve as training samples. A calibration process can be implemented in various methods such as manual calibration. In the present step, to train the fraudulent transaction detection model, a training sample associated with a fraudulent transaction operation needs to be obtained. Specifically, the obtained classification sample set can include a fraudulent transaction sample set that is also referred to as a “black sample set” and a normal operation sample set that is also referred to as a “white sample set”. The black sample set includes black samples associated with fraudulent transaction operations, and the white sample set includes white samples associated with normal operations.

To obtain the black sample set, an operation that is predetermined as a fraudulent transaction is first obtained, and then a predetermined quantity of user operations prior to the fraudulent transaction of a user are further obtained from an operation record of the user. These user operations and user operations calibrated as fraudulent transactions are arranged in chronological order, to constitute a user operation sequence. For example, if a user operation O0 is calibrated as a fraudulent transaction, a predetermined quantity of operations prior to the operation O0, for example, n operations, are obtained to obtain continuous operations O1, O2, . . . , and On. These operations together with O0 are arranged in chronological order, to constitute a user operation sequence (O0, O1, O2, . . . , and On). Certainly, the operation sequence may also be reversed: from On to O1 and O0. In an implementation, the calibrated fraudulent transaction operation O0 is at an endpoint of the operation sequence. In addition, the time interval between adjacent user operations in the user operation sequence is further obtained, and these time intervals constitute a time sequence. It can be understood that a user record that records a user operation history usually includes a plurality of records, and in addition to an operation name of a user operation, each record further includes a timestamp when the user performs the operation. The time interval between user operations can be easily obtained by using the timestamp information, to obtain the time sequence. For example, for the described user operation sequence (O0, O1, O2, . . . , and On), a corresponding time sequence (x1, x2, . . . , and xn) can be obtained, and xi is a time interval between an operation Oi-1 and an operation Oi.

For the white sample set associated with the normal user operations, a user operation sequence and a time sequence of the white sample are obtained in a similar way. To be specific, an operation that is predetermined as a normal transaction is obtained, and then a predetermined quantity of user operations prior to the normal operation of the user are obtained from the operation record of the user. These user operations and user operations calibrated as normal operations are arranged in chronological order, to also constitute a user operation sequence. In the user operation sequence, the calibrated normal transaction operation is also at an endpoint of the operation sequence. In addition, the time interval between adjacent user operations in the user operation sequence is obtained, and these time intervals constitute a time sequence.

As such, the obtained classification sample set includes a plurality of calibration samples (including a sample that is calibrated as a fraudulent transaction and a sample that is calibrated as a normal transaction), and each calibration sample includes the user operation sequence and the time sequence. The user operation sequence includes the predetermined quantity of user operations, and the predetermined quantity of user operations use a user operation whose category is calibrated as an endpoint, and are arranged in chronological order. The user operation whose category is calibrated is an operation that is calibrated as a fraudulent transaction or an operation that is calibrated as a normal transaction. The time sequence includes a time interval between adjacent user operations in the predetermined quantity of user operations.

After the described classification sample set is obtained, the fraudulent transaction detection model can be trained by using the sample set. In an implementation, the fraudulent transaction detection model usually uses a convolutional neural network (CNN) algorithm model.

The CNN is a commonly used neural network model in the field of image processing, and can usually include processing layers such as a convolution layer and a pooling layer. At the convolution layer, local feature extraction and operation are performed on an entered matrix or vector with a larger dimension, to generate several feature maps. A calculation module used for local feature extraction and operation is also referred to as a filter or a convolution kernel. The size of the filter or the convolution kernel can be set and adjusted based on an actual demands. In addition, a plurality of convolution kernels can be disposed, to extract features of different aspects for the same local area.

After the convolution processing, generally, pooling processing is further performed on a convolution processing result. The convolution processing can be considered as a process of splitting an entire input sample to a plurality of local areas and describing features of the local areas. To describe the entire sample, features at different locations of different areas further need to be aggregated and counted, to perform dimensionality reduction, improve results, and avoid overfitting. The aggregation operation is referred to as pooling, and pooling can be classified into average pooling, maximum pooling, etc. based on a specific pooling method.

Usually, there are several hidden layers in the convolutional neural network, to further process a result obtained after the pooling. When the convolutional neural network is used for classification, a result obtained after convolution layer processing, pooling layer processing, hidden layer processing, etc. can be entered to the classifier, to classify input samples.

As described above, in an implementation, the fraudulent transaction detection model uses a CNN model. Correspondingly, the fraudulent transaction detection model includes at least the convolution layer and the classifier layer. The convolution layer is used to perform convolution processing on entered sample data, and the classifier layer is used to classify initially processed sample data. Because the classification sample set used for training has been obtained in step 21, in the following steps, calibration sample data in the classification sample set can be entered to the convolutional neural network for processing.

Specifically, in step 22, first convolution processing is performed on the user operation sequence in the calibration sample at the convolution layer, to obtain the first convolution data; in step 23, second convolution processing is performed on the time sequence in the calibration sample, to obtain the second convolution data.

The first convolution processing in step 22 can be conventional convolution processing. To be specific, a local feature is extracted from the user operation sequence by using a convolution kernel of a certain size, and an arithmetic operation is performed on the extracted feature by using a convolution algorithm associated with the convolution kernel.

In an implementation, the user operation sequence is represented as a vector and is entered to the convolution layer. Convolution processing is directly performed on the operation sequence vector at the convolution layer. A convolution processing result is usually represented as a matrix, or an output result in a vector form can be output through matrix-vector conversion.

In another implementation, before being entered to the convolution layer, the user operation sequence is first processed to obtain an operation matrix.

More specifically, in an implementation, the user operation sequence is processed as the operation matrix by using a one-hot encoding method. The one-hot encoding method is also referred to as a one-hot encoding method, and can be used to process discrete and discontinuous features as a single feature for encoding in machine learning. In an example, if a user operation sequence (O0, O1, O2, . . . , and On) that is to be processed includes m different operations, each operation can be converted into an m-dimensional vector. The vector includes only one element that is 1, and other elements are 0, therefore, the ith element is 1 is corresponding to the ith operation. As such, the user operation sequence can be processed to obtain an operation matrix of m*(n+1), and each row represents one operation, and is corresponding to one m-dimensional vector. A matrix obtained after the one-hot encoding processing is usually relatively sparse.

In another implementation, the user operation sequence is processed as the operation matrix by using a word embedding model. The word embedding model is a model used in natural language processing (NLP), and is used to convert a single word into a vector. In the simplest model, a group of features are constructed for each word to serve as corresponding vectors. Further, to reflect the relationship between words, for example, a category relationship or a subordinate relationship, a language model can be trained in various methods, to optimize vector expression. For example, a word2vec tool includes a plurality of word embedding methods, so that vector expression of a word can be quickly obtained, and the vector expression can reflect an analogy relationship between words. As such, each operation in the user operation sequence can be converted into a vector by using the word embedding model, and correspondingly, the entire operation sequence is converted into the operation matrix.

A person skilled in the art should know that the user operation sequence can be further processed as the matrix in another method. For example, a matrix expression form of the user operation sequence can be also obtained by multiplying the operation sequence in the vector form by a matrix that is defined or learned in advance.

When the user operation sequence is converted into the matrix, the first convolution data obtained after the first convolution processing is generally also a matrix. Certainly, the first convolution data in the vector form can also be output through matrix-vector conversion.

In step 23, second convolution processing is further performed on the time sequence in the calibration sample at the convolution layer, to obtain the second convolution data.

In an implementation, the time sequence can be represented as a vector and is entered to the convolution layer. Dedicated convolution processing, namely, second convolution processing is performed on the time sequence at the convolution layer, to obtain the second convolution data.

Specifically, in an implementation, a plurality of elements in the time sequence are successively processed by using a convolution kernel of a predetermined length k, to obtain a time adjustment vector A serving as the time adjustment convolution data: A=(a1, a2, . . . , and as).

It can be understood that a dimension s of the time adjustment vector A obtained after the second convolution processing depends on a quantity of elements in the original time sequence and a length of the convolution kernel. In an implementation, the length k of the convolution kernel is set, so that the dimension s of the output time adjustment vector A is corresponding to a dimension of the first convolution data. More specifically, when the first convolution accumulation obtained after the first convolution processing is a convolution matrix, the dimension s of the output time adjustment vector A is corresponding to a quantity of columns of the first convolution data. For example, if the time sequence includes n elements, namely, (x1, x2, . . . , and xn), and the length of the convolution kernel is k, the dimension s of the obtained time adjustment vector A is equal to (n−k+1). By adjusting k, s and a quantity of columns of the convolution matrix can be equivalent.

More specifically, in an example, a process of the second convolution processing can include: obtaining a vector element ai in the time adjustment vector A by using the following formula:

$${a}_{i} = f ( - {\sum }_{j = 1}^{k} {x}_{i + j} * {C}_{j} ) , \qquad ( 1 )$$

where

ƒ is a transformation function, and is used to compress a value to a predetermined range, and xᵢ is the i^{th} element in the time sequence. It can be learned that each element aᵢ in A is obtained after a convolution operation is performed on elements (xᵢ₊, xᵢ₊₂, . . . , and xᵢ₊ₖ) in the time sequence by using the convolution kernel of the length k, and Cⱼ is a parameter associated with the convolution kernel. More specifically, Cⱼ can be considered as a weight factor described in the convolution kernel.

To avoid positive infinity of a summation result, a range is limited by using the transformation function ƒ. The transformation function ƒ can be set as required. In an implementation, the transformation function ƒ uses the tanh function. In another implementation, the transformation function ƒ uses the exponential function. In still another implementation, the transformation function uses the sigmoid function. The transformation function ƒ can also be in another form.

In an implementation, the time adjustment vector A can be further operated to obtain second convolution data in more forms such as a matrix form and a value form.

For example, after the second convolution processing, the time adjustment vector A is obtained serving as the second convolution data.

In step 24, the first convolution data obtained in step 22 is combined with the second convolution data obtained in step 23, to obtain the time adjustment convolution data.

In an implementation, the first convolution data obtained in step 22 is in a vector form, and the second convolution data obtained in step 23 is the described time adjustment vector A. In this case, in step 24, the two vectors can be combined in a cross product method and a connection method, to obtain the time adjustment convolution data.

In another implementation, the first convolution obtained in step 22 is a convolution matrix, and the time adjustment vector A is obtained in step 23. As described above, the dimension s of the time adjustment vector A can be set to be corresponding to a quantity of columns of the convolution matrix. As such, in step 24, point multiplication can be performed on the convolution matrix and the time adjustment vector A for combination, and a matrix obtained after the point multiplication is used as the time adjustment convolution data.

That is, Cₒ=Cᵢₙ⊙A

Cᵢₙ is the convolution matrix obtained in step 22, A is the time adjustment vector, and Cₒ is the time adjustment convolution data obtained after the combination.

In another implementation, the first convolution data and/or the second convolution data are in another form. In this case, the combination algorithm in step 24 can be adjusted accordingly, to combine the first convolution data and the second convolution data. As such, the time sequence corresponding to the user operation sequence is introduced to the obtained time adjustment convolution data, and therefore a time sequence and a time interval in the user operation process are introduced.

In step 25, the obtained time adjustment convolution data is entered to the classifier layer, and the fraudulent transaction detection model is trained based on the classification result of the classifier layer.

It can be understood that entered input sample data is analyzed at the classifier layer based on a predetermined classification algorithm, to further provide a classification result. The whole fraudulent transaction detection model can be trained based on the classification result of the classifier layer. More specifically, the classification result of the classifier layer (for example, samples are classified into a fraudulent transaction operation and a normal operation) can be compared with a calibration classification status of an input sample (that is, the sample is actually calibrated as a fraudulent transaction operation or a normal operation), to determine a loss function for classification. Then, derivation is performed on the classification loss function for gradient transfer, to modify various parameters in the fraudulent transaction detection model, and then training and classification are performed again until the classification loss function is within an acceptable range. As such, the fraudulent transaction detection model is trained.

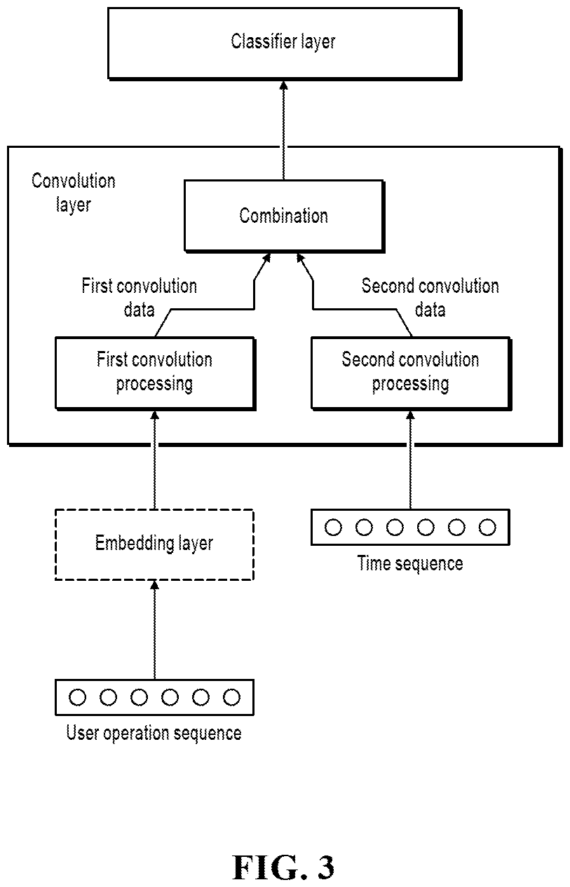

FIG. 3 is a schematic diagram illustrating a fraudulent transaction detection model, according to an implementation. As shown in FIG. 3, the fraudulent transaction detection model usually uses a convolutional neural network (CNN) structure that includes a convolution layer and a classifier layer. The model is trained by using a calibrated fraudulent transaction operation sample and a normal operation sample, and each sample includes a user operation sequence and a time sequence. The user operation sequence includes a predetermined quantity of user operations that use a user operation calibrated as a fraudulent transaction operation/a normal operation as an endpoint, and the time sequence includes a time interval between adjacent user operations.

As shown in FIG. 3, the user operation sequence and the time sequence that the first convolution processing and the second convolution processing are respectively performed on are separately entered to the convolution layer. Then, first convolution data obtained after the first convolution processing is combined with second convolution data obtained after the second convolution processing, to obtain time adjustment convolution data. A specific algorithm for first convolution processing, second convolution processing, and combination processing is described above, and details are omitted here for simplicity. The obtained time adjustment convolution data is entered to the classifier layer for classification, to obtain a classification result. The classification result is used to determine the classification loss function, to adjust model parameters and further train the model.

In an implementation, before being entered to the convolution layer, the user operation sequence further passes through an embedding layer, and the embedding layer is used to process the user operation sequence to obtain an operation matrix. A specific processing method can include a one-hot encoding method, a word embedding model, etc.

In the model in FIG. 3, the first convolution data obtained after the first convolution processing is combined with the second convolution data obtained after the second convolution processing, to obtain the time adjustment convolution data. The combination process plays a role of aggregation and counting, so that pooling processing in a conventional convolutional neural network can be saved. Therefore, a pooling layer is not included in the model in FIG. 3. With reference to the obtained time adjustment convolution data, because the time sequence is introduced, and classification of the classifier layer considers a time interval of a user operation, so that a more accurate and more comprehensive fraudulent transaction detection model can be obtained through training.

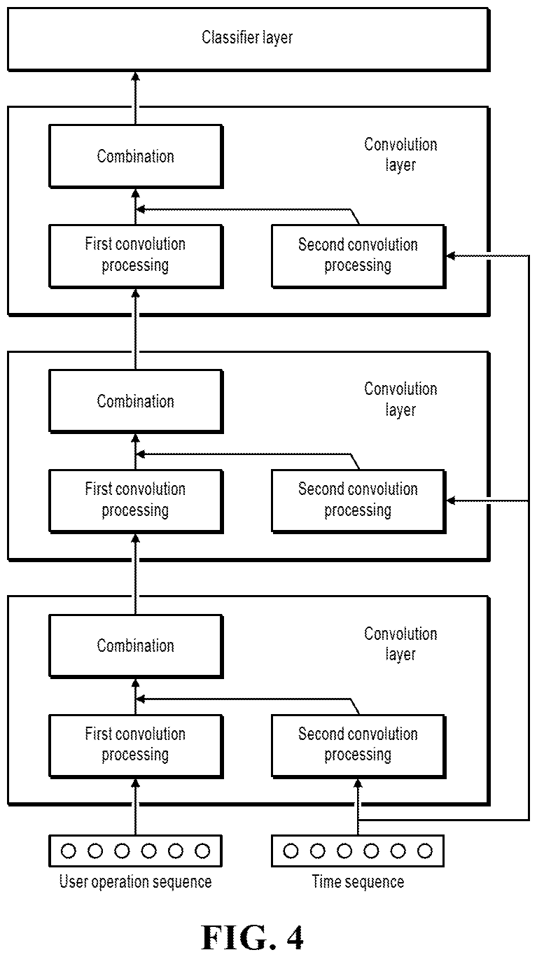

FIG. 4 is a schematic diagram illustrating a fraudulent transaction detection model, according to another implementation. As shown in FIG. 4, the fraudulent transaction detection model includes a plurality of convolution layers (there are three convolution layers as shown in FIG. 4). Actually, for a relatively complex input sample, performing multiple convolution processing by using a plurality of convolution layers is common in a convolutional neural network. When there are a plurality of convolution layers, as shown in FIG. 4, at each convolution layer, first convolution processing is performed on the user operation sequence, second convolution processing is performed on the time sequence, and the first convolution data obtained after the first convolution processing is combined with the second convolution data obtained after the second convolution processing, to obtain the time adjustment convolution data. Time adjustment convolution data obtained at a previous convolution layer is used as a user operation sequence of a next convolution layer for processing, and time adjustment convolution data obtained at the last convolution layer is output to the classifier layer for classification. As such, time adjustment convolution processing of a plurality of convolution layers is implemented, and the fraudulent transaction detection model is trained by using operation sample data obtained after the time adjustment convolution processing.

For both the model with a single convolution layer shown in FIG. 3 and the model with a plurality of convolution layers shown in FIG. 4, because a time sequence is introduced in sample data, and the second convolution data is introduced in the convolution layer to serve as a time adjustment parameter, a training process of the fraudulent transaction detection model considers a time sequence of a user operation and an operation time interval, therefore, a fraudulent transaction can be detected more accurately and more comprehensively by using the fraudulent transaction detection model obtained through training.

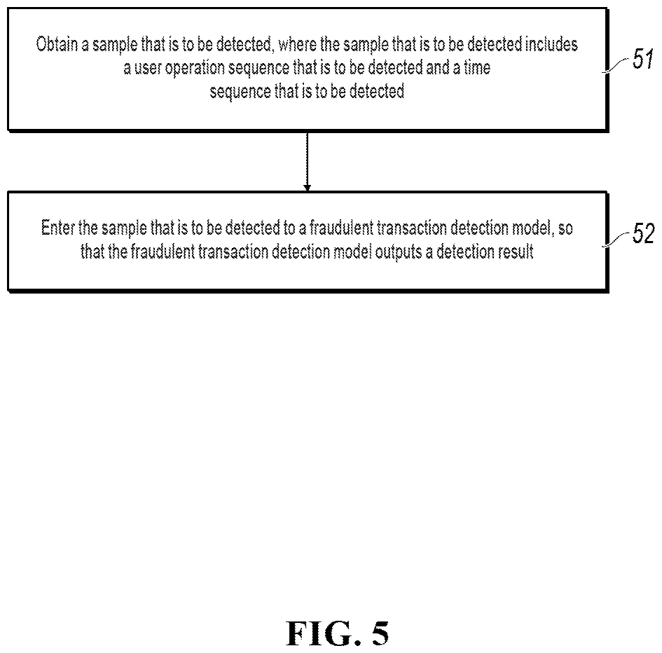

According to another implementation, a method for detecting a fraudulent transaction is further provided. FIG. 5 is a flowchart illustrating a method for detecting a fraudulent transaction, according to an implementation. The method can be executed by any computing platform having a computing and processing capability. As shown in FIG. 5, the method includes the following steps.

First, in step 51, a sample that is to be detected is obtained. It can be understood that composition of the sample that is to be detected is the same as composition of a calibration sample used for training a fraudulent transaction detection model. Specifically, when there is a need to detect whether a certain user operation, namely, a user operation that is to be detected, is a fraudulent transaction operation, a predetermined quantity of user operations prior to the operation are obtained. These user operations constitute a user operation sequence that is to be detected. The user operation sequence that is to be detected includes a predetermined quantity of user operations, and these user operations use an operation that is to be detected as an endpoint, and are arranged in chronological order. A time sequence that is to be detected is further obtained, and the time sequence includes a time interval between adjacent user operations in the user operation sequence that is to be detected.

After the sample that is to be detected is obtained, in step 52, the sample that is to be detected is entered to the fraudulent transaction detection model obtained through training by using the method in FIG. 2, so that the fraudulent transaction detection model outputs a detection result.

More specifically, in step 52, the sample that is to be detected is entered to a convolution layer of the fraudulent transaction detection model obtained through training, so that first convolution processing and second convolution processing are respectively performed on the user operation sequence that is to be detected and the time sequence that is to be detected in the sample that is to be detected, to obtain time adjustment convolution data; the time adjustment convolution data is entered to a classifier layer of the fraudulent transaction detection model, and a detection result is obtained from the classifier layer.

In an implementation, before the sample that is to be detected is entered to the fraudulent transaction detection model, the user operation sequence that is to be detected is processed to obtain an operation matrix that is to be detected.

Corresponding to the training process of the model, the entered sample that is to be detected also includes a feature of the time sequence during the detection. In the detection process, the fraudulent transaction detection model analyzes the entered sample that is to be detected, based on various parameters set during the training, including: performing convolution processing on the time sequence, combining the time sequence with the user operation sequence, and performing classification based on a combination result. As such, the fraudulent transaction detection model can identify and detect a fraudulent transaction more comprehensively and more accurately.

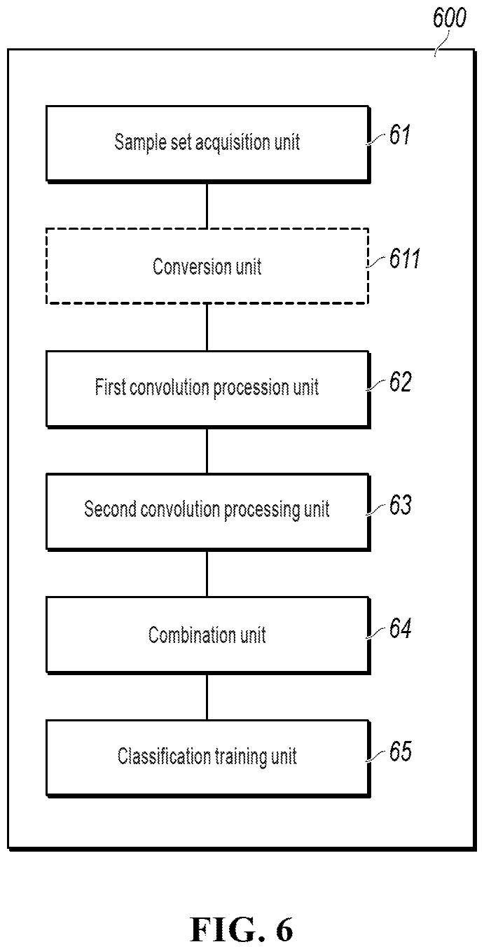

According to another implementation, an apparatus for training a fraudulent transaction detection model is further provided. FIG. 6 is a schematic block diagram illustrating an apparatus for training a fraudulent transaction detection model, according to an implementation, and the fraudulent transaction detection model obtained through training includes a convolution layer and a classifier layer. As shown in FIG. 6, the training apparatus 600 includes: a sample set acquisition unit 61, configured to obtain a classification sample set, where the classification sample set includes a plurality of calibration samples, the calibration sample includes a user operation sequence and a time sequence, the user operation sequence includes a predetermined quantity of user operations, the predetermined quantity of user operations are arranged in chronological order, and the time sequence includes a time interval between adjacent user operations in the user operation sequence; a first convolution processing unit 62, configured to perform first convolution processing on the user operation sequence at the convolution layer, to obtain first convolution data; a second convolution processing unit 63, configured to perform second convolution processing on the time sequence, to obtain second convolution data; a combination unit 64, configured to combine the first convolution data with the second convolution data, to obtain time adjustment convolution data; and a classification training unit 65, configured to enter the time adjustment convolution data in the classifier layer, and train the fraudulent transaction detection model based on a classification result of the classifier layer.

In an implementation, the apparatus further includes a conversion unit 611, configured to process the user operation sequence to obtain an operation matrix.

In an implementation, the conversion unit 611 is configured to process the user operation sequence by using a one-hot encoding method or a word embedding model to obtain an operation matrix.

In an implementation, the second convolution processing unit 63 is configured to successively process a plurality of elements in the time sequence by using a convolution kernel of a predetermined length k, to obtain a time adjustment vector A serving as the second convolution data, where a dimension of the time adjustment vector A is corresponding to a dimension of the first convolution data.

In a further implementation, the second convolution processing unit 63 is configured to obtain a vector element aᵢ in the time adjustment vector A by using the following formula:

$${a}_{i} = f ( - {\sum }_{j = 1}^{k} {x}_{i + j} * {C}_{j} ) ,$$

where ƒ is a transformation function, xᵢ is the i^{th} element in the time sequence, and Cⱼ is a parameter associated with the convolution kernel.

In a further implementation, the transformation function ƒ is one of a tanh function, an exponential function, and a sigmoid function.

In an implementation, the combination unit 64 is configured to perform point multiplication combining on a matrix corresponding to the first convolution data and a vector corresponding to the second convolution data.

In an implementation, the convolution layer of the fraudulent transaction detection model includes a plurality of convolution layers, and correspondingly, the apparatus further includes a processing unit (not shown), configured to use time adjustment convolution data obtained at a previous convolution layer as a user operation sequence of a next convolution layer for processing, and output time adjustment convolution data obtained at the last convolution layer to the classifier layer.

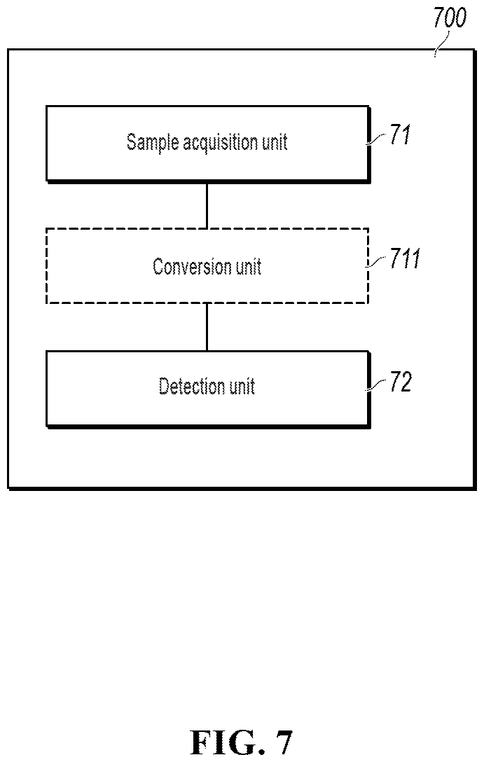

According to another implementation, an apparatus for detecting a fraudulent transaction is further provided. FIG. 7 is a schematic block diagram illustrating an apparatus for detecting a fraudulent transaction, according to an implementation. As shown in FIG. 7, the detection apparatus 700 includes: a sample acquisition unit 71, configured to obtain a sample that is to be detected, where the sample that is to be detected includes a user operation sequence that is to be detected and a time sequence that is to be detected, the user operation sequence that is to be detected includes a predetermined quantity of user operations, the predetermined quantity of user operations are arranged in chronological order, and the time sequence that is to be detected includes a time interval between adjacent user operations in the user operation sequence that is to be detected; and a detection unit 72, configured to enter the sample that is to be detected to a fraudulent transaction detection model, so that the fraudulent transaction detection model outputs a detection result, where the fraudulent transaction detection model is a model obtained through training by using the apparatus shown in FIG. 6.

In an implementation, the detection unit 72 is configured to enter the sample that is to be detected to a convolution layer of the fraudulent transaction detection model, so that first convolution processing and second convolution processing are respectively performed on the user operation sequence that is to be detected and the time sequence that is to be detected in the sample that is to be detected, to obtain time adjustment convolution data; and enter the time adjustment convolution data to a classifier layer of the fraudulent transaction detection model, and obtain a detection result from the classifier layer.

In an implementation, the apparatus 700 further includes a conversion unit 711, configured to process the user operation sequence that is to be detected to obtain an operation matrix that is to be detected.

An improved fraudulent transaction detection model can be trained by using the apparatus shown in FIG. 6, and the apparatus in FIG. 7 detects an entered sample based on the fraudulent transaction detection model obtained through training, to determine whether the sample is a fraudulent transaction. In the previously described fraudulent transaction detection model obtained through training, the entered sample includes a feature of the time sequence, and after convolution processing is performed on the feature of the time sequence, the time sequence is combined with the user operation sequence. Therefore, an important factor, namely, the time interval of the user operation is introduced in the model, so that the detection result is more comprehensive and more accurate.

According to another implementation, a computer readable storage medium is further provided. The computer readable storage medium stores a computer program, and when being executed on a computer, the computer program enables the computer to perform the method described in FIG. 2 or FIG. 5.

According to yet another implementation, a computing device is further provided, and includes a memory and a processor. The memory stores executable code, and when executing the executable code, the processor implements the method described in FIG. 2 or FIG. 5.

A person skilled in the art should be aware that in the described one or more examples, functions described in the present disclosure can be implemented by hardware, software, firmware, or any combination of them. When the present disclosure is implemented by the software, the functions can be stored in the computer readable medium or transmitted as one or more instructions or code in the computer readable medium.

The objectives, technical solutions, and benefits of the present disclosure are further described in detail in the described specific implementations. It should be understood that the descriptions are merely specific implementations of the present disclosure, but are not intended to limit the protection scope of the present disclosure. Any modification, equivalent replacement, or improvement made on the basis of the technical solutions of the present disclosure shall fall within the protection scope of the present disclosure.

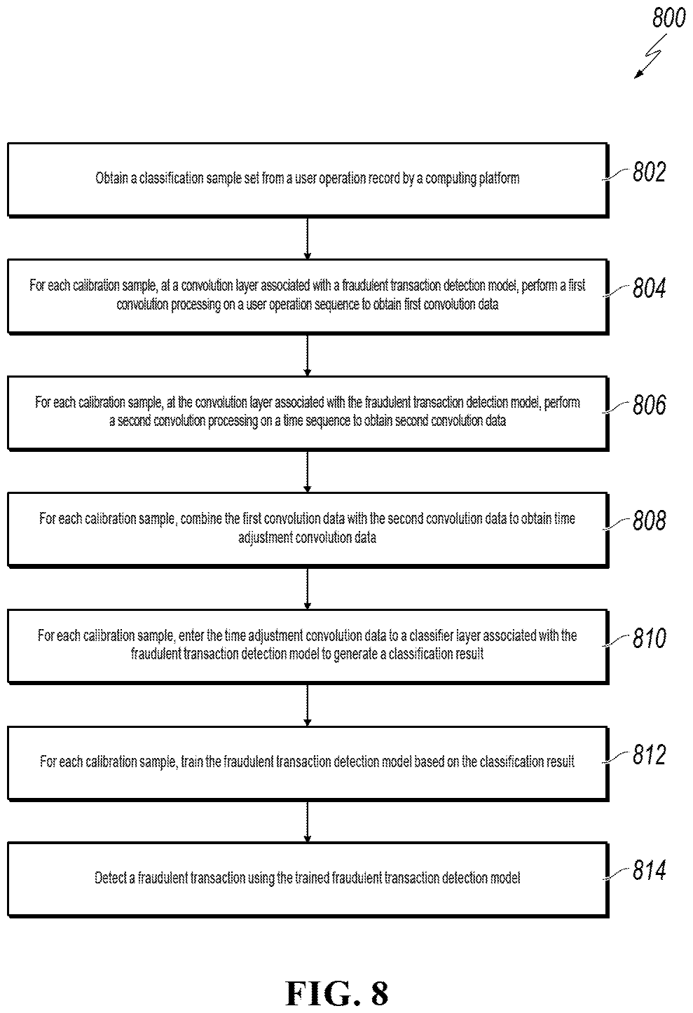

FIG. 8 is a flowchart illustrating an example of a computer-implemented method 800 for training a fraudulent transaction model, according to an implementation of the present disclosure. For clarity of presentation, the description that follows generally describes method 800 in the context of the other figures in this description. However, it will be understood that method 800 can be performed, for example, by any system, environment, software, and hardware, or a combination of systems, environments, software, and hardware, as appropriate. In some implementations, various steps of method 800 can be run in parallel, in combination, in loops, or in any order.

At 802, a classification sample set is obtained from a user operation record by a computing platform, wherein the classification sample set includes a purality of calibration samples, and where each calibration sample of the plurality of calibration samples includes a user operation sequence and a time sequence.

In some implementations, the classification sample set further includes a plurality of fraudulent transaction samples and a plurality of normal operation samples. Each of the fraudulent transaction samples of the plurality of fraudulent transaction samples includes a fraudulent transaction operation and a fraudulent operations sequence comprising historical operations prior to the fraudulent transaction operation. Each of the normal samples of the plurality of normal operation samples includes a normal operation and a normal operation sequence comprising historical operations prior to the normal operation. From 802, method 800 proceeds to 804.

At 804, for each calibration sample, at a convolution layer associated with a fraudulent transaction detection model, a first convolution processing is performed on the user operation sequence to obtain first convolution data.

In some implementations, the first convolution processing comprises: extracting a local feature from the user operation sequence by using a convolution kernel associated with the CNN; and performing an arithmetic operation on the extracted local feature by using a convolution algorithm associated with the convolution kernel to output a convolution processing result as the first convolution data.

In some implementations, the fraudulent transaction detection model is a convolutional neural network (CNN) algorithm model. In such implementations, the time sequence is a vector, where the second convolution processing comprises: successively processing a plurality of vector elements in the time sequence by using a convolution kernel associated with the CNN to obtain a time adjustment vector; where each vector element in the time adjustment vector is obtained by:

$${a}_{i} = f ( - {\sum }_{j = 1}^{k} {x}_{i + j} * {C}_{j} ) ,$$

where aᵢ represents a vector element in a time adjustment vector A; f represents a transformation function that is used to compress a value to a predetermined range; xᵢ represents a i^{th} element in the time sequence; and Cⱼ represents a parameter associated with the convolution kernel, where Cⱼ is considered as a weight factor described in the convolution kernel. From 804, method 800 proceeds to 806.

At 806, for each calibration sample, at the convolution layer associated with the fraudulent transaction detection model, a second convolution processing is performed on the time sequence to obtain second convolution data. From 806, method 800 proceeds to 808.

At 808, for each calibration sample, the first convolution data is combined with the second convolution data to obtain time adjustment convolution data. From 808, method 800 proceeds to 810.

At 810, for each calibration sample, the time adjustment convolution data is entered to a classifier layer associated with the fraudulent transaction detection model to generate a classification result. From 810, method 800 proceeds to 812.

At 812, for each calibration sample, the fraudulent transaction detection model is trained based on the classification result. In some implementations, training the fraudulent detection model comprises: performing a classification by comparing the classification result obtained from the classifier layer with a calibration classification status of an input sample to determine a loss function; and iteratively performing a derivation on the classification loss function for a gradient transfer to modify a plurality of parameters in the fraudulent transaction detection model until the classification loss function is within a predetermined range. From 812, method 800 proceeds to 814.

At 814, a fraudulent transaction is detected using the trained fraudulent transaction detection model. In some implementations, detecting the fraudulent transaction comprises: obtaining a to-be-detected sample, where the to-be-detected sample includes a to-be-detected user operation sequence and a to-be-detected time sequence; entering the to-be-detected sample into a convolution layer associated with the trained fraudulent transaction detection model to perform a first convolution processing on the to-be-detected user operation sequence and a second convolution processing on the to-be-detected time sequence to obtain to-be-detected time adjustment convolution data; and entering the to-be-detected time adjustment convolution data into the classifier layer associated with the trained fraudulent transaction detection model to obtain a detection result. After 814, method 800 can stop.

Implementations of the present application can solve technical problems in training a fraudulent transaction detection model. Fraudulent transactions need to be quickly detected and identified, so that corresponding actions can be taken to avoid or reduce a user's property loses and to improve security of network financial platforms. Traditionally, methods such as logistic regression, random forest, and deep neural networks are used to detect fraudulent transactions. However, these detection methods are not comprehensive, and generated results do not meet user accuracy expectations. What is needed is a technique to bypass issues associated with conventional methods, and to provide a more efficient and accurate method to detect fraudulent transactions in financial platforms.

Implementation of the present application provides methods and apparatuses for improving fraudulent transactions detection by training a fraudulent transaction model. According to these implementations, to train a fraudulent transaction detection model, a training sample set can be obtained from a user operation record recorded in the server. Each sample includes a user operation sequence and a corresponding time sequence. The computing platform trains the fraudulent transaction detection model based on the operation sequence and the time sequence. More specifically, the user operation sequence and the corresponding time sequence are processed by using a convolutional neural network, to train the fraudulent transaction detection model. After the fraudulent transaction detection model is obtained through training, a user operation sequence and a time sequence are also extracted from a transaction sample that is to be detected, and the user operation sequence and the time sequence are entered to the model obtained through training, to output a detection result, that is, whether a current transaction that is to be detected is a fraudulent transaction.

The described subject matter provides several technical effects. First, in the process of training the fraudulent transaction detection model, the computing platform introduces a time sequence corresponding to the user operation sequence, so that the model can consider the time sequence of a user operation and an operation interval to more comprehensively describe and obtain a feature of the fraudulent transaction, and to more effectively detect the fraudulent transaction. Further, the convolution processing technique used in the described solution can be considered to be a process of splitting an entire input sample into a plurality of local areas and describing features of the local areas. To describe the entire sample, features at different locations of different areas further need to be aggregated and counted, to perform dimensionality reduction, improve results, and to avoid overfitting. In addition, because a time sequence is introduced in sample data, and the second convolution data is introduced in the convolution layer to serve as a time adjustment parameter, a training process of the fraudulent transaction detection model considers a time sequence of a user operation and an operation time interval, therefore, a fraudulent transaction can be detected more accurately and more comprehensively by using the fraudulent transaction detection model obtained through training.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method, comprising:
obtaining, by a computing platform, a classification sample set from a user operation record, wherein the classification sample set includes a plurality of calibration samples, and wherein each calibration sample of the plurality of calibration samples includes a user operation sequence and a time sequence;
for each calibration sample:
at a convolution layer associated with a fraudulent transaction detection model, performing a first convolution processing on the user operation sequence to obtain first convolution data;
at the convolution layer associated with the fraudulent transaction detection model, performing a second convolution processing on the time sequence to obtain second convolution data;
combining the first convolution data with the second convolution data to obtain time adjustment convolution data;
entering the time adjustment convolution data to a classifier layer associated with the fraudulent transaction detection model to generate a classification result; and
training the fraudulent transaction detection model based on the classification result; and
detecting a fraudulent transaction using the trained fraudulent transaction detection model.

2. The computer-implemented method of claim 1, wherein the classification sample set further includes a plurality of fraudulent transaction samples and a plurality of normal operation samples; wherein each of the fraudulent transaction samples of the plurality of fraudulent transaction samples includes a fraudulent transaction operation and a fraudulent operations sequence comprising historical operations prior to the fraudulent transaction operation; and wherein each of the normal samples of the plurality of normal operation samples includes a normal operation and a normal operation sequence comprising historical operations prior to the normal operation.

3. The computer-implemented method of claim 1, wherein the fraudulent transaction detection model is a convolutional neural network (CNN) algorithm model.

4. The computer-implemented method of claim 3, wherein the first convolution processing comprises:
extracting a local feature from the user operation sequence by using a convolution kernel associated with the CNN; and
performing an arithmetic operation on the extracted local feature by using a convolution algorithm associated with the convolution kernel to output a convolution processing result as the first convolution data.

5. The computer-implemented method of claim 3, wherein the time sequence is a vector, and wherein the second convolution processing comprises:
successively processing a plurality of vector elements in the time sequence by using a convolution kernel associated with the CNN to obtain a time adjustment vector; and wherein each vector element in the time adjustment vector is obtained by:
$${a}_{i} = f ( - {\sum }_{j = 1}^{k} {x}_{i + j} * {C}_{j} ) ,$$
where:
aᵢ represents a vector element in a time adjustment vector A;
f represents a transformation function that is used to compress a value to a predetermined range;
xᵢ represents a i^{th} element in the time sequence; and
Cⱼ represents a parameter associated with the convolution kernel, wherein Cⱼ is considered as a weight factor described in the convolution kernel.

6. The computer-implemented method of claim 1, wherein training the fraudulent detection model comprises:
performing a classification by comparing the classification result obtained from the classifier layer with a calibration classification status of an input sample to determine a loss function; and
iteratively performing a derivation on the loss function for a gradient transfer to modify a plurality of parameters in the fraudulent transaction detection model until the classification loss function is within a predetermined range.

7. The computer-implemented method of claim 1, wherein detecting the fraudulent transaction comprises:
obtaining a to-be-detected sample, wherein the to-be-detected sample includes a to-be-detected user operation sequence and a to-be-detected time sequence;
entering the to-be-detected sample into a convolution layer associated with the trained fraudulent transaction detection model to perform a first convolution processing on the to-be-detected user operation sequence and a second convolution processing on the to-be-detected time sequence to obtain to-be-detected time adjustment convolution data; and
entering the to-be-detected time adjustment convolution data into the classifier layer associated with the trained fraudulent transaction detection model to obtain a detection result.

8. A non-transitory, computer-readable medium storing one or more instructions executable by a computer system to perform operations comprising:
obtaining, by a computing platform, a classification sample set from a user operation record, wherein the classification sample set includes a plurality of calibration samples, and wherein each calibration sample of the plurality of calibration samples includes a user operation sequence and a time sequence;
for each calibration sample:
at a convolution layer associated with a fraudulent transaction detection model, performing a first convolution processing on the user operation sequence to obtain first convolution data;
at the convolution layer associated with the fraudulent transaction detection model, performing a second convolution processing on the time sequence to obtain second convolution data;
combining the first convolution data with the second convolution data to obtain time adjustment convolution data;
entering the time adjustment convolution data to a classifier layer associated with the fraudulent transaction detection model to generate a classification result; and
training the fraudulent transaction detection model based on the classification result; and
detecting a fraudulent transaction using the trained fraudulent transaction detection model.

9. The non-transitory, computer-readable medium of claim 8, wherein the classification sample set further includes a plurality of fraudulent transaction samples and a plurality of normal operation samples; wherein each of the fraudulent transaction samples of the plurality of fraudulent transaction samples includes a fraudulent transaction operation and a fraudulent operations sequence comprising historical operations prior to the fraudulent transaction operation; and wherein each of the normal samples of the plurality of normal operation samples includes a normal operation and a normal operation sequence comprising historical operations prior to the normal operation.

10. The non-transitory, computer-readable medium of claim 8, wherein the fraudulent transaction detection model is a convolutional neural network (CNN) algorithm model.

11. The non-transitory, computer-readable medium of claim 10, wherein the first convolution processing comprises:
extracting a local feature from the user operation sequence by using a convolution kernel associated with the CNN; and
performing an arithmetic operation on the extracted local feature by using a convolution algorithm associated with the convolution kernel to output a convolution processing result as the first convolution data.

12. The non-transitory, computer-readable medium of claim 10, wherein the time sequence is a vector, and wherein the second convolution processing comprises:
successively processing a plurality of vector elements in the time sequence by using a convolution kernel associated with the CNN to obtain a time adjustment vector; and wherein each vector element in the time adjustment vector is obtained by:
$${a}_{i} = f ( - {\sum }_{j = 1}^{k} {x}_{i + j} * {C}_{j} ) ,$$
where:
aᵢ represents a vector element in a time adjustment vector A;
f represents a transformation function that is used to compress a value to a predetermined range;
xᵢ represents a i^{th} element in the time sequence; and
Cⱼ represents a parameter associated with the convolution kernel, wherein Cⱼ is considered as a weight factor described in the convolution kernel.

13. The non-transitory, computer-readable medium of claim 8, wherein training the fraudulent detection model comprises:
performing a classification by comparing the classification result obtained from the classifier layer with a calibration classification status of an input sample to determine a loss function; and
iteratively performing a derivation on the loss function for a gradient transfer to modify a plurality of parameters in the fraudulent transaction detection model until the classification loss function is within a predetermined range.

14. The non-transitory, computer-readable medium of claim 8, wherein detecting the fraudulent transaction comprises:
obtaining a to-be-detected sample, wherein the to-be-detected sample includes a to-be-detected user operation sequence and a to-be-detected time sequence;
entering the to-be-detected sample into a convolution layer associated with the trained fraudulent transaction detection model to perform a first convolution processing on the to-be-detected user operation sequence and a second convolution processing on the to-be-detected time sequence to obtain to-be-detected time adjustment convolution data; and
entering the to-be-detected time adjustment convolution data into the classifier layer associated with the trained fraudulent transaction detection model to obtain a detection result.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
obtaining, by a computing platform, a classification sample set from a user operation record, wherein the classification sample set includes a plurality of calibration samples, and wherein each calibration sample of the plurality of calibration samples includes a user operation sequence and a time sequence;
for each calibration sample:
at a convolution layer associated with a fraudulent transaction detection model, performing a first convolution processing on the user operation sequence to obtain first convolution data;
at the convolution layer associated with the fraudulent transaction detection model, performing a second convolution processing on the time sequence to obtain second convolution data;
combining the first convolution data with the second convolution data to obtain time adjustment convolution data;
entering the time adjustment convolution data to a classifier layer associated with the fraudulent transaction detection model to generate a classification result; and
training the fraudulent transaction detection model based on the classification result; and
detecting a fraudulent transaction using the trained fraudulent transaction detection model.

16. The computer-implemented system of claim 15, wherein the fraudulent transaction detection model is a convolutional neural network (CNN) algorithm model.

17. The computer-implemented system of claim 16, wherein the first convolution processing comprises:
extracting a local feature from the user operation sequence by using a convolution kernel associated with the CNN; and
performing an arithmetic operation on the extracted local feature by using a convolution algorithm associated with the convolution kernel to output a convolution processing result as the first convolution data.

18. The computer-implemented system of claim 16, wherein the time sequence is a vector, and wherein the second convolution processing comprises:
successively processing a plurality of vector elements in the time sequence by using a convolution kernel associated with the CNN to obtain a time adjustment vector; and wherein each vector element in the time adjustment vector is obtained by:
$${a}_{i} = f ( - {\sum }_{j = 1}^{k} {x}_{i + j} * {C}_{j} ) ,$$
where:
aᵢ represents a vector element in a time adjustment vector A;
f represents a transformation function that is used to compress a value to a predetermined range;
x₁ represents a i^{th} element in the time sequence; and
Cⱼ represents a parameter associated with the convolution kernel, wherein Cⱼ is considered as a weight factor described in the convolution kernel.

19. The computer-implemented system of claim 15, wherein training the fraudulent detection model comprises:
performing a classification by comparing the classification result obtained from the classifier layer with a calibration classification status of an input sample to determine a loss function; and
iteratively performing a derivation on the loss function for a gradient transfer to modify a plurality of parameters in the fraudulent transaction detection model until the classification loss function is within a predetermined range.

20. The computer-implemented system of claim 15, wherein detecting the fraudulent transaction comprises:
obtaining a to-be-detected sample, wherein the to-be-detected sample includes a to-be-detected user operation sequence and a to-be-detected time sequence;
entering the to-be-detected sample into a convolution layer associated with the trained fraudulent transaction detection model to perform a first convolution processing on the to-be-detected user operation sequence and a second convolution processing on the to-be-detected time sequence to obtain to-be-detected time adjustment convolution data; and
entering the to-be-detected time adjustment convolution data into the classifier layer associated with the trained fraudulent transaction detection model to obtain a detection result.
